(19) United States
(12) Patent Application Publication
(10) Pub. No.: US 2026/0284919 A1
(43) Pub. Date: Sep. 24, 2026

(54) PROCESSING TABLE, PROCESSING ASSEMBLY AND METHOD FOR PROCESSING ELASTOMERIC MATERIAL

(71) Applicant: VMI HOLLAND B.V., Epe (NL)

(72) Inventors: Teunis Johannes VERBRUGGEN, Epe (NL); Gerrit Roy NIJLAND, Epe (NL); Marcel Alfred SMITS, Epe (NL)

(21) Appl. No.: 19/474,390

(22) PCT Filed: Mar. 28, 2024
(86) PCT No.: PCT/EP2024/058482

§ 371 Date: Oct. 10, 2025

(30) Foreign Application Priority Data
Apr. 14, 2023 (NL) 2034582

(51) Int. Cl. B26D 7/01; B23Q 3/08

(52) U.S. Cl. CPC B26D 7/018; B23Q 3/08

(57) ABSTRACT

A processing table is provided for processing elastomeric material on a support surface. The processing table is provided with a plurality of suction apertures that are distributed over the support surface in an aperture pattern that defines a first retaining area and a second retaining area on the support surface extending between a first side and a second side of the processing table. The aperture pattern further defines a processing area between the first retaining area and the second retaining area. The processing area comprises at least an area between a first limit line extending from the first side to the second side and a second limit line extending from the first side to the second side at an oblique processing angle with respect to the first limit line and intersecting with said first limit line between the first side and the second side.

### BACKGROUND

The invention relates to a processing table, a processing assembly and a method for processing elastomeric material, in particular for processing tire components. Said tire components may for example comprise sheets or strips of elastomeric material. The processing may for example comprise cutting the elastomeric material along a cutting line or stitching the elastomeric material along a splice line.

FIGS. 2 and 4 show a known splicing assembly 1001 for splicing two tire components 91, 92. The splicing assembly 1001 comprises a splice table 1002 with a support surface 1020 for supporting the tire components thereon. The splice table 1002 is further provided with a plurality of suction apertures 1080 that are distributed over the support surface 1020 of the splice table 1002. The suction apertures 1080 are, at one end, open to the support surface 1020 and, at the other end, connected to a pressure system for retaining the tire components to the support surface 1020 of the splice table 1002 by applying a negative pressure to said suction apertures 1080.

The splicing assembly further comprises a stitching roller 1003 for stitching the tire components 91, 92 together along a splice line L0.

### SUMMARY OF THE INVENTION

A disadvantage of the known splicing assembly 1001 is that over time, debris and/or residue 1090 may accumulate in the suction apertures 1080 of the splice table 1002. In particular, the stitching roller 1003 may push the tire components 91, 92 into one or more of the suction apertures 1080 along the splice line L0. Said accumulated debris or residue may clog the suction apertures 1080 which may reduce the retaining power of the splice table 1002. Moreover, the debris or residue may be sucked through the vacuum suction apertures 1080 and into the pressure system. Accordingly, the debris or residue may clog the tubing and/or the valves of the pressure system. Moreover, the debris or residue may damage the valves or the pump of the pressure system. Additionally, pressing the tire components 91, 92 into the suction apertures 1080 may damage said tire components 91, 92 and may negatively impact the quality of a resulting tire.

It is an object of the present invention to provide a processing table, a processing assembly and a method for processing elastomeric material in which the elastomeric material can be retained more effectively and/or reliably.

According to a first aspect, the present invention relates to a processing table for processing elastomeric material, in particular tire components, wherein the processing table comprises a table body with a support surface for supporting the elastomeric material in a support plane, wherein the support surface extends in a first direction from a first side of the processing table to a second side of the processing table opposite to the first side over a table width, wherein the processing table is further provided with a plurality of suction apertures that are distributed over the table body according to an aperture pattern, wherein the suction apertures are open at the support surface towards the support plane, wherein the aperture pattern defines a first retaining area and a second retaining area of the support surface, wherein the first retaining area and the second retaining area each extend from the first side to the second side of the processing table, wherein the first retaining area and the second retaining area are spaced apart in a second direction perpendicular to the first direction, wherein the suction apertures are located within said first retaining area and said second retaining area, wherein the aperture pattern further defines a processing area of the support surface, wherein the processing area extends from the first side to the second side of the processing table and between the first retaining area and the second retaining area in the second direction, wherein the processing area comprises at least a part between a first limit line extending from the first side to the second side and a second limit line extending from the first side to the second side at an oblique processing angle with respect to the first limit line and intersecting with said first limit line between the first side and the second side. The processing table may for example be a splice table for supporting and/or retaining two elastomeric materials, in particular two tire components, to be spliced or stitched together. Alternatively, the table may for example be a cutting table for supporting and/or retaining an elastomeric material, in particular a tire component, to be cut.

Preferably, the aperture pattern comprises a dense pattern of suction apertures in the first retaining area and the second retaining area, and a sparse pattern of suction apertures in the processing area. In other words, the density of the suction apertures is much higher in the first and second retaining areas as compared to the density of the suction apertures in the processing area. The processing area, i.e. the sparse pattern, can be free of suction apertures. Preferably, the suction apertures are exclusively arranged or distributed over the first retaining area and the second retaining area. Accordingly, the elastomeric material can be processed, e.g. cut, stitched or spliced, on the processing area without pressing the elastomeric material into the suction apertures. Accordingly, the elastomeric material can be reliably and/or effectively retained on either side of the processing area by the vacuum apertures in the first retaining area and the second retaining area, respectively.

Moreover, the processing area comprises the area between the first limit line and the second limit line. Hence, the elastomeric material supported and/or retained on the processing table can be processed along a continuous range of processing lines between said first and second limit line.

In a preferred embodiment thereof, the processing angle is at least three degrees, preferably wherein the processing angle is between four and forty-five degrees, more preferably between five and thirty degrees, most preferably between five and fifteen degrees.

In an embodiment thereof, at least a part of the first retaining area extends between the processing area and the first side in the first direction. Additionally or alternatively, at least a part of the second retaining area extends between the processing area and the second side in the first direction. Accordingly, the suction apertures within the first retaining area and/or the second retaining area can retain the elastomeric material close to the first limit line and/or the second limit line at the first side and/or the second side of the processing table. Hence, the elastomeric material can be retained more reliably.

In a further embodiment, the aperture pattern comprises a first pattern of suction apertures within the first retaining area and a second pattern of suction apertures within the second retaining area, wherein the first pattern extends between the first side and the second side along a part of a first pattern line that extends from the first side to the second side to define a part of a boundary between the first retaining area and the processing area, and wherein the second pattern extends between the first side and the second side along at least a part of a second pattern line that extends from the first side to the second side to define at least a part of a boundary between the second retaining area and the processing area. In other words the aperture pattern can be free of apertures along the remainder of the first pattern line. The first limit line can extend between the first pattern and the first side or the second side of the processing table. Hence a larger processing angle can be obtained between the first limit line and the second limit line without encountering suction apertures. Said larger processing angle can be obtained without enlarging a mutual distance between the first pattern and the second pattern. Hence, said first pattern and said second pattern can retain the elastomeric material closer to the first limit line and the second limit line. Hence, the elastomeric material can be retained more reliably.

In a preferred embodiment thereof, the first pattern extends over twenty to eighty percent of the table width, preferably wherein the first pattern extends over thirty to seventy percent of the table width, more preferably over forty to sixty percent of the table width. The first pattern may for example extend over fifty percent or substantially fifty percent of the table width.

In a further embodiment, the first pattern line and the first limit line are parallel. Hence, the first pattern line can more reliably retain the elastomeric material along the first limit line.

In another embodiment, the first pattern line extends perpendicular to the first side. Hence, the first pattern of suction apertures can reliably retain elastomeric material when processing said material in a direction substantially perpendicular to the first side of the table.

In a further embodiment, the first pattern extends from the first side towards the second side. Hence, the first pattern can more reliably retain the elastomeric material along the first pattern line up to the first side. Accordingly, the remaining part of the first pattern line, i.e. the part between the first pattern and the second side, can be free of suction apertures.

In a further embodiment, the first pattern is a row, a column or an array of suction apertures. For example, the first pattern may comprise a single row of suction apertures. Said row can reliably and/or efficiently retain the elastomeric material along the first pattern line. Accordingly, processing areas without suction apertures may be defined on either side of the first pattern.

In a further embodiment, the second pattern extends over twenty to eighty percent of the table width, preferably wherein the second pattern extends over thirty to seventy percent of the table width, more preferably over forty to sixty percent of the table width. Similar to the first pattern, the second pattern can allow the first limit line or the second limit line to pass between said second pattern and the first side or the second side. Hence, a larger processing angle can be obtained.

In an embodiment thereof, the second pattern extends from the second side towards the first side. Preferably, the first pattern and the second pattern extend from opposite sides of the processing table. Accordingly, the limit lines can pass both between the first pattern and the second side and between the second pattern and the first side. Hence, an even larger processing angle can be obtained. In particular, a larger processing angle with respect to the first pattern line and the second pattern line can be obtained.

In another embodiment thereof, the second pattern is a row, a column or an array of suction apertures. As described in relation to the first pattern, a row, column or array can reliably retain the elastomeric material along the second pattern line.

In a further embodiment, the first pattern line and the second pattern line are parallel, wherein the first pattern line and the second pattern line are spaced apart over a first mutual distance. Preferably, the first mutual distance is larger than a spacing between the suction apertures along the first pattern line and/or the second pattern line. Hence, the processing area can be sufficiently large to allow the processing of the elastomeric material, while said elastomeric material can be reliably retained along the boundaries between the retaining areas and the processing area.

In a further embodiment, the aperture pattern further comprises a third pattern of suction apertures within the first retaining area, wherein the third pattern extends between the first side and the second side along at least a part of a third pattern line different from the first pattern line, wherein the third pattern line extends from the first side to the second side to define a further part of a boundary between the first retaining area and the processing area. In other words, the border or boundary between the first retaining area and the processing area can be defined by at least the first pattern line and the third pattern line. The third pattern can retain the elastomeric material along said third pattern line. Hence, the elastomeric material can be retained more reliably along the boundary or border between the first retaining area and the processing area.

In an embodiment thereof, the first pattern extends from the first side towards the second side and wherein the third pattern extends from the second side towards the first side over twenty to eighty percent of the table width, preferably wherein the third pattern extends over thirty to seventy percent of the table width, more preferably over forty to sixty percent of the table width. Accordingly, the third pattern can reliably and/or effectively retain the elastomeric material at or near the second side.

In a further embodiment, the first pattern line and the third pattern line are parallel, wherein the first pattern line and the third pattern line are spaced apart over a second mutual distance. Preferably, the third pattern line is located opposite to the second line with respect to the first line.

In an embodiment thereof, the second mutual distance is larger than a spacing between the suction apertures along the first pattern line and/or the third pattern line. In other words, the suction apertures are distributed more densely along the first boundary and/or the third pattern line. Hence, the elastomeric material can be more reliably retained along said pattern lines. Accordingly, the second mutual distance can allow a part of a processing device, e.g. a splice wheel or a knife, to pass between the suction apertures that are arranged along the respective pattern lines.

In a further embodiment thereof, the first pattern line is arranged between the second pattern line and the third pattern line in the second direction, preferably wherein the first pattern line is centered between the second pattern line and the third pattern line in the second direction. Preferably, the second pattern line and the third pattern line are symmetric about the first pattern line. Hence, a further processing area can be defined opposite or mirrored to the previously discussed processing area. Accordingly, the angular range of the limit lines can be increased.

In an alternative embodiment, the first pattern line and the third pattern line intersect at a first intersection between the first side and the second side. In other words, the first pattern line and the third pattern line extend at an oblique mutual angle. Accordingly, the first pattern line and the third pattern line can be arranged closer to the first limit line and the second limit line. Preferably, the third pattern line extends parallel to the second limit line. Thus, the elastomeric material can be retained more reliably along said limit lines.

In a further embodiment thereof, the first pattern extends from the first side towards and/or up to the first intersection, and/or wherein the third pattern extends from the second side towards and/or up to the first intersection. Hence, the first pattern and the third pattern can form a continuous or contiguous pattern along a border or boundary between the first retaining area and the processing area. Thus, the elastomeric material can be retained more reliably at said first retaining area.

In a further embodiment, the aperture pattern further comprises a fourth pattern of suction apertures within the second retaining area, wherein the fourth pattern extends between the first side and the second side along at least a part of a fourth pattern line different from the second pattern line, wherein the fourth pattern line extends from the first side to the second side to define a further part of a boundary between the second retaining area and the processing area. In other words, the border or boundary between the second retaining area and the processing area can be defined by at least the second pattern line and the fourth pattern line. The fourth pattern can retain the elastomeric material along said fourth pattern line. Hence, the elastomeric material can be retained more reliably along the boundary or border between the second retaining area and the processing area.

In an embodiment thereof, the second pattern extends from the second side towards the first side, and wherein the fourth pattern extends from the first side towards the second side over twenty to eighty percent of the table width, preferably wherein the fourth pattern extends over thirty to seventy percent of the table width, more preferably over forty to sixty percent of the table width. Accordingly, the fourth pattern can reliably and/or effectively retain the elastomeric material at or near the first side.

In a further embodiment, the third pattern line and the fourth pattern line are parallel, and wherein the third pattern line and the fourth pattern line are spaced apart over a third mutual distance. Preferably, the fourth pattern line and the first pattern line are located on opposite sides of the second pattern line in the second direction.

In an embodiment thereof, the third mutual distance is larger than a spacing between the suction apertures along the third pattern line and/or the fourth pattern line. In other words, the suction apertures are distributed more densely along the second boundary and/or the fourth pattern line. Hence, the elastomeric material can be more reliably retained along said pattern lines. Accordingly, the third mutual distance can allow a part of a processing device, e.g. a splice wheel or a knife, to pass between the suction apertures that are arranged along the respective pattern lines.

In an embodiment thereof, the second pattern line is arranged between the first pattern line and the fourth pattern line in the second direction, preferably, wherein the second pattern line is centered between the first pattern line and the fourth pattern line in the second direction. Preferably, the first pattern line and the fourth pattern line are symmetric about the second pattern line. Hence, a further processing area can be defined opposite or mirrored to the previously discussed processing area. Accordingly, the angular range of the limit lines can be increased.

In an alternative embodiment thereof, the second pattern line and the fourth pattern line intersect at a second intersection between the first side and the second side, wherein the fourth pattern extends from the first side towards and/or up to the second intersection, and/or wherein the second pattern extends from the second side towards and/or up to the second intersection. Accordingly, the second pattern line and the fourth pattern line can be arranged closer to the first limit line and the second limit line. Preferably, the fourth pattern line extends parallel to the second limit line. Thus, the elastomeric material can be retained more reliably along said limit lines. Moreover, the second pattern and the fourth pattern can form a continuous or contiguous pattern along a the border or boundary between the second retaining area and the processing area. Hence, the elastomeric material can be retained more reliably at said second retaining area.

In a further embodiment the processing area is a first processing area, wherein aperture pattern further defines a second processing area on the support surface that is displaced in the second direction relative to the first processing area. Preferably, the aperture pattern further defines one or more further processing areas that are distributed in the second direction. Hence, the elastomeric material can be processed in at least two processing areas. For example, multiple tire components can be processed on the same processing table without the need to displace the tire components for each successive processing step. In particular, a plurality of tire components may be positioned on the support surface, such that said tire components overlap in one or more of the processing areas. Accordingly, the tire components can be stitched together in said one or more processing areas.

In an embodiment thereof, the aperture pattern defines a third retaining area and a fourth retaining area on the support surface, wherein the second processing area extends between the third retaining area and the fourth retaining area in the second direction, and wherein the suction apertures are further distributed within said third retaining area and said fourth retaining area.

In an embodiment thereof, the third retaining area is the second retaining area. In other words, the first processing area and the second processing area are separated in the second direction by the second retaining area. Accordingly, the aperture pattern may define further or subsequent alternating processing areas and retaining areas.

In a further embodiment, the first processing area and the second processing area are spaced apart in the second direction. In particular, said processing areas are spaced apart by one ore more retaining areas. Said one or more retaining areas can reliably retain the elastomeric material along the first processing area and along the second processing area.

In an alternative embodiment thereof, the first processing area and the second processing area partially overlap.

In yet another embodiment, the first processing area and the second processing area are equally shaped and/or equally dimensioned. Hence, a series of equally shaped tire components can be processed.

In a further embodiment, the processing table further comprises a vacuum system that is connected to the suction apertures for applying a negative pressure to said suction apertures for retaining the elastomeric material. The vacuum system or pressure system can apply a negative pressure or vacuum to the suction apertures for retaining the elastomeric material.

According to a second aspect, the present invention relates to a processing assembly for processing elastomeric material, in particular tire components, wherein the processing assembly comprises a processing table according to the first aspect of the present invention and a processing device for processing the elastomeric material on said processing table, wherein the processing device is arranged for processing the elastomeric material along a processing line extending from the first side to the second side of the processing table within the processing area.

The processing device may for example comprise a stitching device for stitching two tire components together or a cutting device for cutting elastomeric material. The processing assembly incorporates the processing table according to the first aspect of the invention. Accordingly, the processing assembly possesses the same advantages as discussed above.

In an embodiment thereof, the processing assembly is further arranged for rotating the processing line between the first limit line and the second limit line. In other words, the processing line can be set at a desired angle with respect to the processing table. Accordingly, the limit line can be adapted to the elastomeric material to be processed, e.g. the limit line can be adapted to match an overlapping splice area of two tire components for splicing said tire components together or the limit line can be adapted to cut an elastomeric material at a desired angle.

In a further embodiment, the processing assembly is further arranged for displacing the processing line in the second direction. Hence, the processing assembly can process the elastomeric material in a further processing area. For example, the processing assembly may stitch a first and second tire component together at the first processing area and may subsequently stitch the second tire component and a third tire component together in a further processing area. Accordingly, multiple tire components can be stitched on the processing table without the need to displace said tire components relative to the processing table. Hence, said tire components can be retained on the processing table. Accordingly, the inaccuracies in the positions of the tire components can be reduced. Hence, the tire components can be stitched more precisely and/or reliably. Thus, the quality of a resulting tire can be improved.

In a further embodiment, the processing device is a stitching device for stitching a first tire component and a second tire component together along the processing line. In other words, said first tire component and said second tire component can be stitched without pressing the elastomeric material in the suction apertures. The first and second tire components can be reliably retained by the first and second retaining areas on either side of the processing area.

In an embodiment thereof, the processing device comprise a stitching roller, wherein the stitching roller has a roller width, and wherein a minimal width of the processing area in a direction perpendicular to the processing line is larger than the width of the stitching roller. Hence, the stitching roller can be rolled along the processing line without encountering suction apertures.

In an alternative embodiment thereof, the processing device is a cutter for cutting a tire component along the processing line. The cutting device can securely retain the elastomeric material along the processing line. Hence, the elastomeric material can be cut more reliably and/or precisely.

According to a third aspect, the present invention provides a method for processing an elastomeric material using the processing assembly according to the second aspect of the invention or the processing table according to the first aspect of the invention, wherein the method comprises the steps of:
a) providing the elastomeric material at the support surface; and
b) processing the elastomeric material along the processing line.

The method of the present invention incorporates the processing table according to the first aspect of the invention and/or the processing assembly according to the second aspect of the invention. Hence, the method has the same advantages as mentioned above.

In an embodiment thereof, the method further comprises retaining the elastomeric material by applying a negative pressure at the plurality of suction apertures in at least one of the first retaining area and the second retaining area. Hence, the elastomeric material can be reliably and/or effectively retained at the first retaining area and the second retaining area. In particular, the elastomeric material can be reliably retained while processing said elastomeric material along an processing line within the processing area.

In a further embodiment, the method further comprises rotating the processing line between the first limit line and the second limit line. In other words, the method comprised adapting or changing an angle of the processing line with respect to the processing table. Said angle of the processing line relative to the processing table can be adapted or changed within the processing area defined by said processing table.

In another embodiment, the elastomeric material comprises a first tire component and a second tire component, wherein step a) comprises:
placing the first tire component at the first retaining area such that a lateral portion of said first tire component extends within the first processing area; and
placing the second tire component at the second retaining area such that a lateral portion of said second tire component overlaps with the lateral portion of the first tire component in the first processing area. Hence, the first tire component and the second tire component can be arranged on the processing table such that no suction apertures are arranged within the overlap of the first tire component and the second tire component. Thus, the tire components be reliably stitched together without pressing the elastomeric material into the suction apertures.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 and shows a splice assembly for stitching elastomeric material according to an exemplary embodiment of the present invention;

FIG. 2 shows a splice assembly according to the prior art;

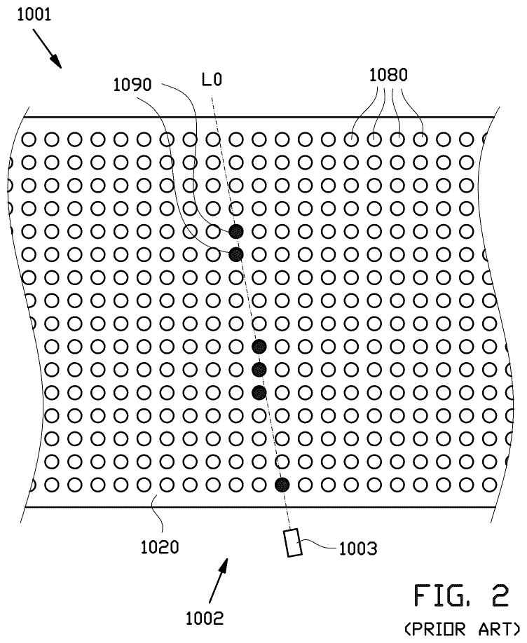

FIG. 3 shows a section view according to the line III-III in FIG. 1;

FIG. 4 shows the section view FIG. 3 according to the prior art situation;

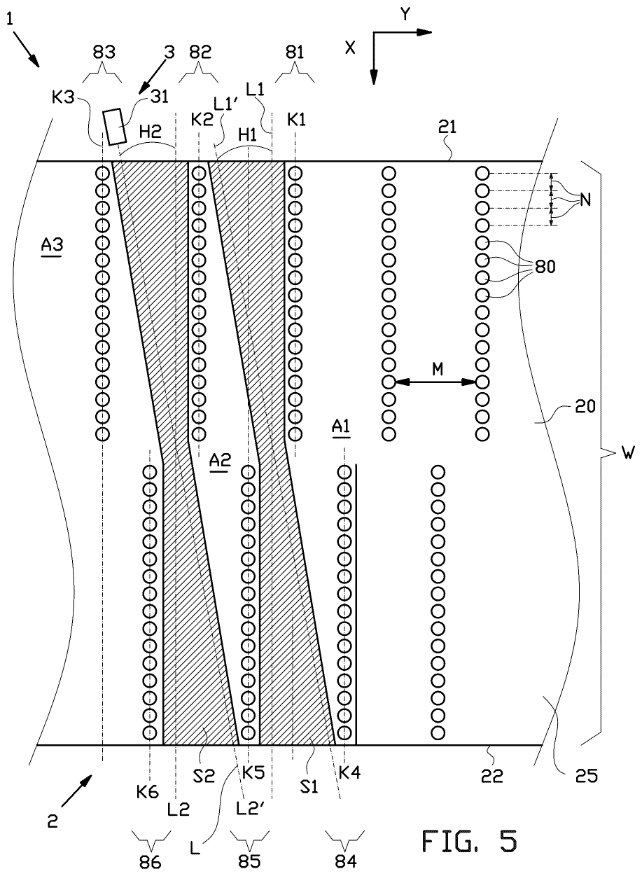

FIGS. 5 and 6 show a detailed view of the splice assembly of FIG. 1;

FIG. 7 shows a cutting assembly according to a further embodiment of the present invention;

FIG. 8 shows an alternative cutting assembly according to another embodiment of the present invention

FIG. 9 shows a alternative splicing assembly according to yet another embodiment of the present invention;

FIGS. 10A-10D show a pressure system according to an embodiment of the present invention;

FIG. 11 shows a supply device for supplying tire components according to an embodiment of the present invention; and

FIG. 12 shows a detailed view of an aperture pattern of a further embodiment of the present invention according to the circle XII in FIG. 1.

### DETAILED DESCRIPTION OF THE INVENTION

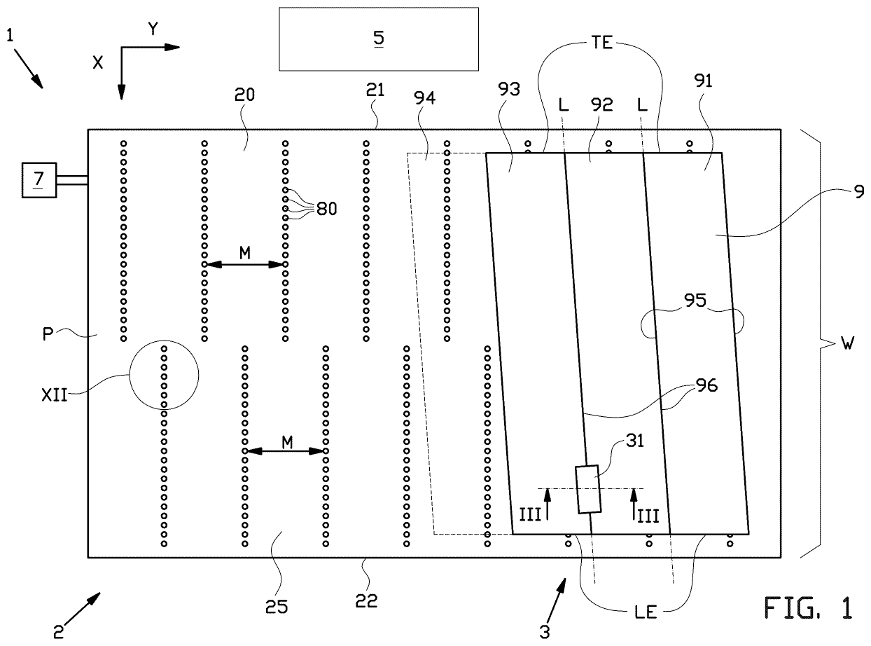

FIGS. 1, 3, 5 and 6 show a splice assembly 1 for splicing or stitching elastomeric material, in particular one or more tire components 91, 92, 93, 94, according to an embodiment of the present invention. In the embodiment as shown, the tire components 91, 92, 93, 94 comprise cord reinforced strips of elastomeric material.

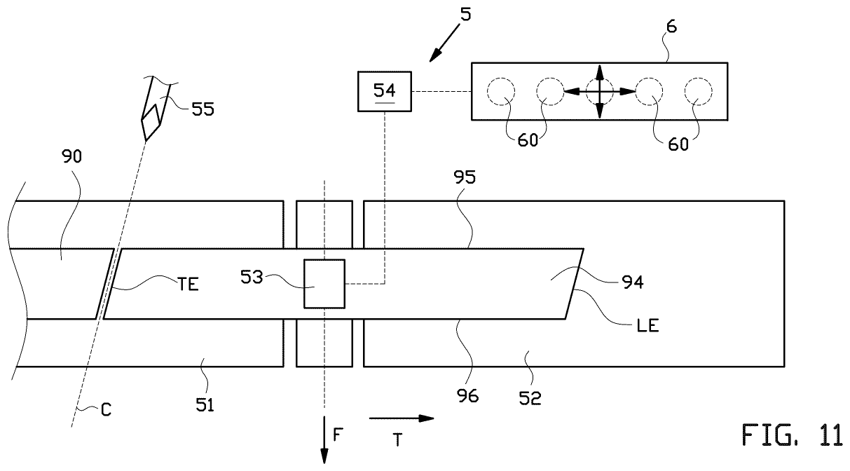

The tire components 91, 92, 93, 94 are longitudinally shaped and extend between a leading end LE and a trailing end TE. The tire components 91, 92, 93, 94, each have a first lateral or longitudinal side 95 and a second lateral or longitudinal side 96 opposite to the first longitudinal side 95. Said longitudinal sides 95, 96 extend between the leading end LE and the trailing end TE of the respective tire component 91, 92, 93, 94. As is shown in FIG. 11, the tire components 91, 92, 93, 94 are cut to length along a cutting line C that extends at an oblique angle with respect to the first lateral side 95 and the second lateral side 96. Accordingly, the tire components 91, 92, 93, 94 are parallelogram shaped or substantially parallelogram shaped. Generally, the tire components 91, 92, 93, 94 the first lateral side 95 extends at an oblique angle with respect to the leading end LE and at an obtuse angle with respect to the trailing end TE. Accordingly, the second lateral side 96 extends at an obtuse angle with respect to the leading end LE and at an oblique angle with respect to the trailing edge TE. Alternatively, the tire components 91, 92, 93, 94 may for example be rectangular or substantially rectangular.

As is further shown in FIG. 1, the splice assembly 1 is arranged to subsequently stitch a plurality of said tire components 91, 92, 93, 94 together along the longitudinal sides 95, 96 thereof to form a single tire component 9, in particular a breaker or body ply.

The splice assembly 1 comprises a splice table 2 for supporting the first tire component 91 and the second tire component. The splice assembly 1 further comprises a stitching device 3 for stitching the tire components 91, 92, 93, 94 together on the splice table 2 along a plurality of splice lines L.

The splice table 2 comprises a table body 25 with a support surface 20 for supporting the tire components 91, 92, 93, 94 in a support plane P. Preferably, the support surface 20 extends in said support plane P. The support plane surface 20 extends between a first side 21 of the splice table 2 and a second side 22 of the splice table 2 opposite to said first side 21. Preferably, the support surface 20 is rectangular or substantially rectangular. In particular, the support surface 20 extends between the first side 21 and the second side 22 in a width direction or first direction X. The splice table 2 extends in the first direction X over a table width W. The splice table 2 further extends in a length direction or second direction Y perpendicular to the first direction Y.

In this particular embodiment, the stitching device 3 comprises a stitching wheel or stitching roller 31. The stitching wheel 31 is movable along a processing line or splice line L. The stitching roller 31 is rotatable about a rotation axis (not shown) that extends perpendicular or substantially perpendicular to the splice line L. Preferably, said rotation axis extends parallel or substantially parallel to the support plane P.

The stitching device 3 is positionable or movable relative to the processing table 2 into a first operational position for stitching a first tire component 91 and a second component 92 together. In said first operational position, the stitching device 3 is positioned such that the splice line L extends from the first side 21 to the second side 22 between a predetermined first primary limit line L1 and a first secondary limit line L1′.

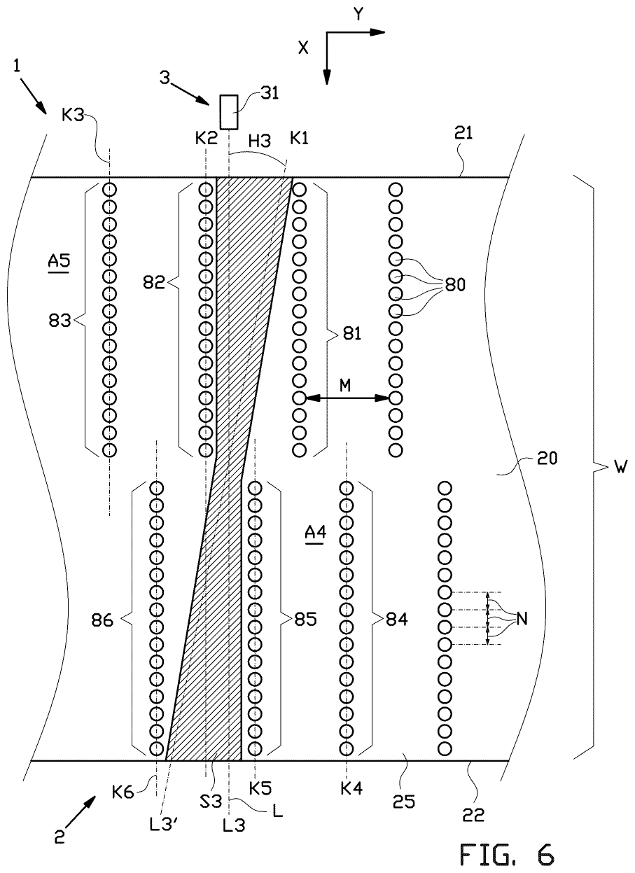

As is further shown in FIGS. 1 and 5, the stitching device 3 is further positionable into a second operational position for stitching the second tire component 92 and a third tire component 93 together. In said second operational position, the stitching device 3 is positioned such that the processing line L extends from the first side 21 to the second side 22 between a predetermined second primary limit line L2 and a second secondary limit line L2′. Preferably, the stitching device 3 is movable relative to the processing table 2 in the second direction Y between the first operational position and the second operational position.

Generally, the tire components 91, 92, 93, 94 are the same or substantially the same. In other words, the tire components 91, 92, 93, 94 have the same or substantially the same dimensions. Accordingly, splice lines L in first operational position and in the second operational position may be parallel.

The stitching device 3 is further positionable into a third operational position for stitching the third tire component 93 to a fourth tire component 94 together and in one or more further operational positions for subsequently stitching the fourth tire component 94 and one or more further tire components together.

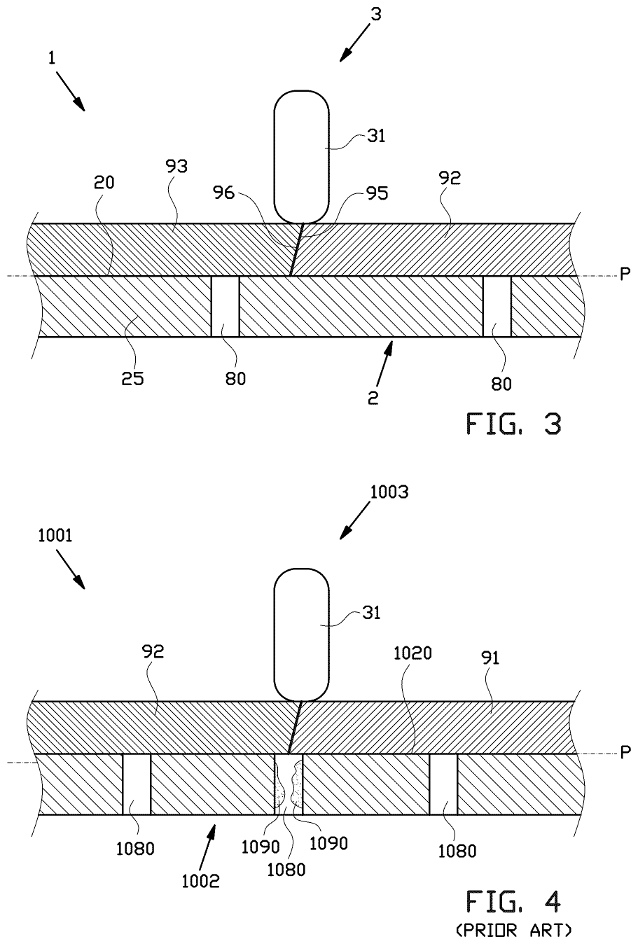

As is shown in FIG. 3, the second tire component 92 and the third tire component 93 are placed on the support surface 20 in an overlapped configuration. In particular, the second longitudinal side 96 of the third tire component 93 is overlapping the first longitudinal side 95 of the second tire component 92. Preferably, said longitudinal sides 95, 96 comprise beveled edges. The stitching device 3 is arranged to roll the stitching roller 31 along the splice line L over an overlapping portion of the first longitudinal side 95 of the third tire component 93 and the second longitudinal side 96 of the second tire component 92 to stich said first third component 93 and said second tire component 92 together.

As is further shown in FIGS. 5 and 6, the stitching device 3 is rotatable in a plane parallel to the support plane P to adapt an angle of the splice line L with respect to the first edge 21. Preferably, the stitching device 3 is rotatable to rotate the splice line L between the first primary limit line L1 and the first secondary limit line L1′.

The splice table 2 is provided with a plurality of vacuum apertures, vacuum cups, suction holes or suction apertures 80 for at least partly retaining the first tire component 91 and the second tire component 92 to the support surface 20. The suction apertures 80 are distributed over the table body 25 and are open towards the support surface 20. In particular, the suction apertures 80 debouch into the support plane P. In the embodiment as shown, the suction apertures 80 are circular or substantially circular.

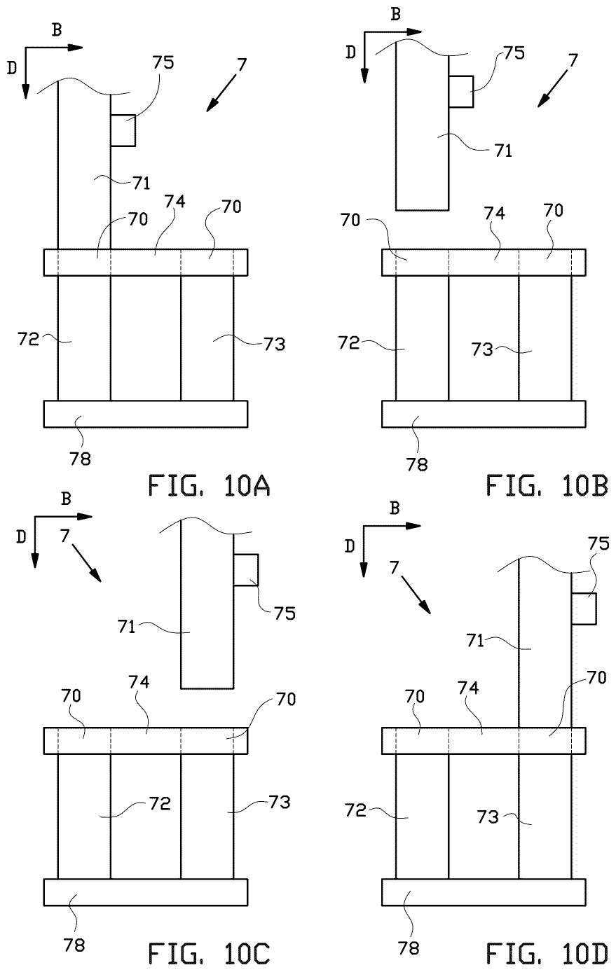

The suction apertures 80 are connected to and/or in fluid communication with a pressure system 7 according to the present invention. Said pressure system is shown in more detail in FIGS. 10A-10B. The pressure system 7 comprises a first duct 71 that is in fluid communication with at least a part of the suction apertures 80 of the splice table 2. In other words the first duct 71 is connected to said suction apertures 80. The pressure system 7 further comprises a second duct 72 and a third duct 73 and a connector 74 for selectively connecting the second duct 72 or the third duct 73 to the first duct 71.

The second duct 72 is connected in fluid communication to a negative pressure source or a vacuum source. In the embodiment as shown, the second duct is connected to the suction or inlet opening of a pump 78. The third duct 73 is connected in fluid communication to a positive pressure source. In the embodiment as shown, the third duct 73 is connected to the outlet or discharge opening of the pump 78. In other words, the second duct 72 and the third duct 73 are connected to the suction opening and the discharge opening, respectively, of the same pump 78. Optionally, the second duct 72 and the third duct 72 may be connected to distinct pumps.

In the embodiment as shown, the connector 74 comprises a seal plate with respective openings 70 at the second duct 72 an the third duct 73. The first duct 71 is selectively connectable to or insertable in said openings 70 to establish a fluid communication with the second duct 72 or the third duct 73, respectively. Preferably, the connector 74 is arranged for sealing a connection and/or creating an air-tight connection between first duct 71 and the second duct 72 or the third duct 73, respectively.

As is further shown in FIGS. 10A-10D, the pressure system 7 comprises a manipulator 75 for moving the first duct 71 between a suction configuration, as shown in FIG. 10A, and a blowing configuration, as shown in FIG. 10D. In particular, the manipulator 75 is arranged for moving the first duct 71 in a coupling direction D for inserting said first duct 71 in a respective opening 70 of the connector 74. The manipulator 75 is further movable in a switching direction B for moving the first duct 71 between a position in line with the second duct 72, as is for example shown in FIGS. 10A and 10B, and a position in line with the third duct 73, as is for example shown in FIGS. 10C and 10D. Said switching direction B is transverse, perpendicular or substantially perpendicular to the coupling direction D.

Alternatively, the manipulator 75 may for example be configured for moving the connector 74 between the suction configuration and the blowing configuration. In other words, the manipulator 75 is configured to effect a mutual displacement between the first duct 71 and the connector 74. Preferably, the first duct 71 comprises a hose (not shown) to improve the movability of said first duct 71 relative to the connector 74. The manipulator 75 can automatically connect the first duct 71 to the second duct 72 or the third duct 73. Hence, the need of an intervention of an operator at or near the pressure system can be eliminated. Hence, worker safety can be improved.

A method of using the pressure system 7, is described hereafter, using FIGS. 10A-10D.

In the suction configuration of FIG. 10A, the first duct 71 is in fluid communication with the second duct 72. Accordingly, the suction apertures 80 are in fluid communication with the inlet opening of the pump 78. The pump 78 applies a suction or negative pressure to the suction apertures 80 in fluid communication with said first duct 71. Accordingly, the suction apertures 80 can apply a suction force to the first tire component 91 and/or the second tire component 92 to retain said first tire component 91 and/or said second tire component 92 to the support surface 20.

As is shown in FIG. 10B, the first duct 71 has been disconnected and/or removed from the connector 74. In particular, the manipulator 75 has displaced the first tube 71 relative to and away from the connector 74 in the coupling direction D. The first duct 71 is no longer in direct fluid communication with either the inlet or the outlet of the pump 78. Accordingly, no forced air pressure is applied to the suction apertures 80 of the processing table 2.

As is shown in FIG. 10C, the first tube 71 been moved to a position in line with the third tube 73. In particular, the manipulator 75 has displaced the first tube 71 relative to the connector 74 in the switching direction B.

In the blowing configuration of FIG. 10D, the first duct 71 has been inserted in the opening of the connector 74 corresponding tot the third duct 73. In particular, the manipulator 75 has displaced the first duct 71 in the coupling direction D. The first duct 71 is now in fluid communication with the third duct 73. Accordingly, the suction apertures 80 of the processing table 2 are in fluid communication with the outlet side of the pump 78. Said pump 78 may now apply a positive pressure or air flow to the suction apertures 80 in fluid communication with said first duct 71. Accordingly, debris, particles and/or contamination may be blown out of the suction apertures 80. Hence, clogging of the suction apertures 80 can be reduced. Additionally, blowing air out of the suction apertures 80 may facilitate the removal of the tire component 91, 92, 93, 94 supported on the processing table 2.

As is best shown in FIGS. 5 and 6, the suction apertures 80 are arranged in an aperture pattern. In the embodiment as shown, the aperture pattern comprises a first pattern 81, a second pattern 82, a third pattern 83 and further patterns that extend from the first side 21 towards the second side 22 of the splice table 2. The aperture pattern further comprises a fourth pattern 84, a fifth pattern 85, a sixth pattern 86 and further patterns that extend from the second side 22 towards the first side 21 of the splice table 2.

The patterns 81, 82, 83, 84, 85, 86 are dense patterns. The patterns 81, 82, 83, 84, 85, 86 are sparsely arranged over the support surface 20 of the table 2. In other words, a spacing between the respective suction apertures 80 within each pattern 81, 82, 83, 84, 85, 86 is much smaller than a spacing between the patterns 81, 82, 83, 84, 85, 86. In the embodiment as shown, the patterns 81, 82, 83, 84, 85, 86 each comprise a one dimensional array, column or row of suction apertures 80. Alternatively, the patterns may for example comprise a two dimensional array or grid. Preferably, the suction apertures 80 within a respective pattern 81, 82, 83, 84, 85, 86 are distributed along the corresponding pattern line K1, K2, K3, K4, K5, K6 with a mutual spacing N. In other words, the suction apertures are densely distributed along the corresponding pattern lines K1, K2, K3, K4, K5, K6. The suction apertures 80 of a respective pattern 81, 82, 83, 84, 85, 86 are arranged along, at or substantially at a corresponding pattern line K1, K2, K3, K4, K5, K6 that extends from the first side 21 to the second side 22 of the support table 2.

In particular, the first pattern 81, the second pattern 82 and the third pattern 83 extend along a first pattern line K1, a second pattern line K2 and a third pattern line K3, respectively. Preferably, the first pattern line K1, the second pattern line K2, and the third pattern line K3 are mutually parallel. In the embodiment as shown, the first, second and third pattern lines K1, K2, K3 extend perpendicular or substantially perpendicular to the first side 21 of the splice table 2. Alternatively, the first, second and third pattern lines K1, K2, K3 may extend at an oblique angle with respect to the first side 21 of the spice table 2.

The first, second and third pattern lines K1, K2, K3 are mutually spaced apart in the second direction Y over a mutual distance M. Preferably, a mutual distance M between the first pattern line K1 and the second pattern line K2 is equal or substantially equal to a mutual distance M between the second pattern line K2 and the third pattern line K3. Said mutual distance M between the respective pattern lines K1, K2, K3 is larger than the mutual spacing N.

In the embodiment as shown, the first pattern 81, the second pattern 82 and the third pattern 83 extend over fifty percent or substantially fifty percent of the table width W of the splice table 2. Preferably, said patterns 81, 82, 83 extend over twenty to eighty percent of the table width W. More preferably, said patterns 81, 82, 83 extend over thirty to seventy percent of the table width W. Most preferably, said patterns 81, 82, 83 extend over forty to sixty percent of the table width W. In the configuration of FIGS. 5 and 6 the first, second and third patterns 81, 82, 83 extend over the same part of the table width W. Alternatively, the first, second and third patterns 81, 82, 83, may extend over distinct lengths along the respective pattern lines K1, K2, K3.

As is further shown in FIGS. 5 and 6, the fourth pattern 84, the fifth pattern 85 and the sixth pattern 86 extend along a fourth pattern line K4, a fifth pattern line K5 and a sixth pattern line K6, respectively. Preferably, the fourth pattern line K4, the fifth pattern line K5, and the sixth pattern line K6 are mutually parallel. In the embodiment as shown, the fourth, fifth and sixth pattern lines K4, K5, K6 extend perpendicular or substantially perpendicular to the fourth side 21 of the splice table 2. Moreover, the fourth, fifth and sixth pattern lines K4, K5, K6 extend parallel to the first, second and third pattern lines K1, K2, K3. Alternatively, the fourth, fifth and sixth pattern lines K4, K5, K6 may extend at an oblique angle with respect to the first, second and third pattern lines K1, K2, K3.

The fourth, fifth and sixth pattern lines K4, K5, K6 are mutually spaced apart in the second direction Y over a mutual distance M. Preferably, a mutual distance M between the fourth pattern line K4 and the fifth pattern line K5 is equal or substantially equal to a mutual distance M between the fifth pattern line K5 and the sixth pattern line K6. More preferably, the mutual spacing between the fourth, fifth and second pattern lines K4, K5, K6 is equal to the mutual spacing between the first, second and third pattern lines K3, K4, K5.

As is shown in FIGS. 5 and 6, the fourth, fifth and sixth pattern lines K4, K5, K6 are placed intermittently with respect to the first, second and third pattern lines K1, K2, K3. In particular, the fifth pattern line K5 is arranged between the first pattern line K1 and the second pattern line K2. The sixth pattern line K6 is arranged between the second pattern line K2 and the third pattern line K3. The first pattern line K1 is arranged between the fourth pattern line K4 and the fifth pattern line K5. Preferably, the fourth, fifth and sixth pattern lines K4, K5, K6 are centered or located in the middle with respect to the first, second and third pattern lines K1, K2, K3, e.g. the fifth pattern line K5 is centered between the first pattern line K1 and the second pattern line K2.

In the embodiment as shown, the fourth pattern 84, the fifth pattern 85 and the sixth pattern 86 extend over fifty percent or substantially fifty percent of the table width W of the splice table 2. Preferably, said patterns 84, 85, 86 extend over twenty to eighty percent of the table width W. More preferably, said patterns 84, 85, 86 extend over thirty to seventy percent of the table width W. Most preferably, said patterns 84, 85, 86 extend over forty to sixty percent of the table width W. In the configuration of FIGS. 5 and 6 the fourth, fifth and sixth patterns 84, 85, 86 extend over the same part of the table width W. Alternatively, the fourth, fifth and sixth patterns 84, 85, 86, may extend over distinct lengths along the respective pattern lines K4, K5, K6. Preferably, the fourth, fifth and sixth patterns 84, 85, 86 extend up to the first, second and third patterns 81, 82, 83 in the first direction X.

As is further shown in FIGS. 5 and 6, the suction apertures 80 on the respective pattern lines K1, K2, K3, K4, K5, K6 are exclusively located within the corresponding patterns 81, 82, 83, 84, 85, 86. In other words, no suction apertures 80 are arranged on the respective pattern lines K1, K2, K3, K4, K5, K6 except for the suction apertures 80 in the corresponding patterns 81, 82, 83, 84, 85, 86. Accordingly, the aperture pattern is free from suction apertures 80 along the remainder of the pattern lines K1, K2, K3, K4, K5, K6.

As is shown in FIGS. 1, 5 and 6, the aperture pattern is repeated in the second direction Y. In other words, further patterns, similar or equal to the first, the second and the third patterns 81, 82, 83 are distributed over the support surface 20 along the first side 21 of the splice table 2 in the second direction Y. Accordingly, further patterns, similar or equal to the fourth, fifth and sixth pattern 84, 85, 86 are distributed over the support surface 20 along the second side 22 of the splice table 2 in the second direction Y. Preferably, said further patterns are distributed at equal intervals.

As is shown in FIG. 5, the aperture pattern defines a first processing area or splice area S1 on the support surface 20 between the suction apertures 80. In other words, the first splice area S1 constitutes a part of the support surface 20. The first splice area S1 extends from the first side 21 to the second side 22 of the table 2. The splicing device 3 is arranged to splice along the splice line L within the first splice area S1.

The aperture pattern further defines a first retaining area A1 and a second retaining area A2 that extend on either side of the first splice area S1 for retaining the first tire component 91 and the second tire component 92, respectively. In other words, the first splice area S1 is arranged between the first retaining area A1 and the second retaining area A2.

The suction apertures 80 are arranged on either side of the first splice area S1 within the first retaining area A1 and the second retaining area A2. In other words, the first splice area S1 is defined as the area between the suction apertures 80 of the first retaining area A1 and the suction apertures 80 of the second retaining area A2. Within said first retaining area A1 and said second retaining area A2 the suction apertures 80 are arranged in a dense pattern. Conversely, within the first splice area S1, the suction apertures 80 are arranged in a sparse pattern. Preferably, the first splice area S1 is free of suction apertures 80.

As can further be seen in FIG. 5, at least a part of the first retaining area A1 extends between the first processing area S1 and the first side 21 of the splice table 2 in the first direction X. More particularly, the first pattern 81 extends between the first splice area S1 and the first side 21 of the splice table 2. Accordingly, at least a part of the second retaining area A2 extends between the first processing area S1 and the second side 22 of the splice table 2 in the first direction X. More particularly, the fifth pattern 85 extends between the first retaining area S1 and the second side 22 of the splice table 2. In other words, the first splice area S1 extends between the first pattern 81 and the second side 22 of the splice table 2 in the first direction X. Moreover, the first splice area S1 extends between the fifth pattern 85 and the first side 21 of the splice table 2 in the first direction X.

In the embodiment as shown in FIG. 5, the first retaining area A1 comprises the suction apertures 80 of the first pattern 81 and the fourth pattern 84. The second retaining area A2 comprises the suction apertures 80 of the second pattern 82 and the fifth pattern 85. Accordingly, the first splice area S1 extends between the suction apertures 80 of the first pattern 81, the second pattern 82, the fourth pattern 84 and the fifth pattern 85. The first splice area S1 comprises at least a part between the first primary limit line L1 and the first secondary limit line L1′. In other words, the first splice area S1 comprises at least the area between said first primary limit line L1 and said first secondary limit line L1′. Additionally, the first splice area S1 may for example comprise at least a part of the area between the first primary limit line L1 and the first pattern line K1, at least a part of the area between the first primary limit line L1 and the fifth pattern line K5, at least a part of the area between the first secondary limit line L1′ and the second pattern line K2, and/or at least a part of the area between the secondary limit line L1′ and the fourth pattern line K4.

The first primary limit line L1 extends parallel to the pattern lines K1, K2, K3, K4, K5, K6. The first primary limit line L1 is arranged between the first pattern line K1 and the fifth pattern line K5. The first secondary limit line L1′ extends at a first splice angle H1 with respect to the first primary limit line LL. Preferably, the first secondary limit line L1′ extends from the intersection of the fourth pattern line K4 with the second side 22 to the intersection of the second pattern line K2 with the first side 21 of the splice table 2. The first secondary limit line L1′ extends over a width in the second direction Y that is larger than the mutual distance M between the first pattern line K1 and the second pattern line K2 and/or the mutual distance M between the fourth pattern line K4 and the fifth pattern line K5. In other words, the first splice area S1 extends over a width in the second direction Y that is larger than the mutual distance M between the first pattern line K1 and the second pattern line K2 and/or the mutual distance M between the fourth pattern line K4 and the fifth pattern line K5.

The splice angle H1 is at least three degrees. Preferably the splice angle H1 is between four and forty-five degrees. More preferably the splice angle H1 is between five and thirty degrees. Most preferably the splice angle H1 is between five and fifteen degrees.

As is further shown in FIG. 5, the aperture pattern defines a second processing area or splice area S2 on the support surface 20 between the suction apertures 80. In other words, the second splice area S2 constitutes a part of the support surface 20. The second splice area S2 extends from the first side 21 to the second side 22 of the table 2. The second splice area S2 is spaced apart from the first splice area S1 by the second retaining area A2 in the second direction Y.

The aperture pattern further defines a third retaining area A3 that extends on the opposite side of the second splice area S2 with respect to the second retaining area A2. In other words, the second splice area S2 is arranged between the second retaining area A2 and the third retaining area A3.

The third retaining area A3 comprises the suction apertures 80 of the third pattern 83 and the sixth pattern 86. Accordingly, the second splice area S2 extends between the suction apertures 80 of the second pattern 82, the third pattern 83, the fifth pattern 85 and the sixth pattern 86. The second splice area S2 comprises at least a part between the second primary limit line L2 and the second secondary limit line L2′. Said second primary limit line L2 and said second secondary limit line L2′ extend at an oblique second splice angle H2. Preferably the second splice angle H2 is equal to the first splice angle H1.

As is shown in FIG. 6, the aperture pattern of the splice table 2 further defines a third splice area S3 on the support surface 20. The third splice area S3 and the first splice area S1 are mirrored relative to the fifth pattern line K5. Accordingly, the third splice area S3 and the first splice area S1 have an overlap between the first pattern 81 and the second pattern 82 of suction apertures 80. More particularly, the third splice area S3 extends between the first pattern 81, the second pattern 82, the fifth pattern 85 and the sixth pattern 86.

At least a part of the third splice area S3 is constituted by the area between a third primary limit line L3 and a third secondary limit line L3′. Said third primary limit line L3 and said third secondary limit line L3′ each extend from the first side 21 to the second side 22 of the splice table 2 and intersect between said first side 21 and said second side 22. The third primary limit line L3 extends parallel to an between the second pattern line K2 and the fifth pattern line K5. The third secondary limit line L3′ extends from the intersection of the first pattern line K1 with the first side 21 to the intersection of the sixth pattern line K6 with the second side 22. The third primary limit line L3 and the third secondary limit line L3′ extend at an oblique third splice angle H3.

Said third splice angle H3 is equal in size but opposite to the first splice angle H1 and the second splice angle H2. Accordingly, the stitching device 3 may stitch two tire components together along a splice line L within the combined angular range of the first splice angle H1 and the third splice angle H3.

As is shown in FIG. 11, the splice assembly 1 further comprises a supply device 5 for supplying the tire components 91, 92, 93, 94 to the splice table 2.

The supply device 5 comprises a first conveyor 51 and a second conveyor 52 downstream of the first conveyor in a transport direction T. The supply device 5 further comprises a detector 53 between the first conveyor 51 and the second conveyor 52 for detecting the lateral or longitudinal edges 95, 96 of the tire components 91, 92, 93, 94 when said tire components are transported in the transport direction T from the first conveyor 51 to the second conveyor 52.

Optionally, the supply device 5 may comprise a cutter 55 for cutting the tire components 91, 92, 93, 94 from a continuous elastomeric strip 90. The cutter 55 comprises a knife that is moveable along a cutting line C. Preferably, a cutting angle of the cutting line C with respect to the transport direction T is adaptable to change a configuration of the tire components 91, 92, 93, 94.

The supply device 5 further comprises a manipulator 6 for transferring the tire components 91, 92, 93, 94 from the second conveyor 52 to the splice table 2. In particular, the manipulator 6 is arranged for picking up the tire components 91, 92, 93, 94 and for depositing said tire components 91, 92, 93, 94, on the support surface 20 of the splice table 2. The manipulator 6 comprises retaining members 60 for retaining the tire components 91, 92, 93, 94. Said retaining members 60 may for example comprise suction cups or needles. Alternatively, when the tire components 91, 92, 93, 94 comprise metallic cord, the retaining members 60 may include magnets.

As is further shown in FIG. 11, the supply device 5 comprises a control unit 54 that is functionally and/or operationally coupled to the detector 53 and the manipulator 6. The control unit 54 is arranged to determine and store a geometry of each tire component 91, 92, 93, 94 based on the measurements of the detector 53. The control unit 54 is further arranged to determine and store for each tire component a position on the second conveyor 52 based on the measurements of the detector 53 and/or the speed of the first conveyor 51 and/or the second conveyor 52.

The control unit 54 is further configured to control the manipulator 6 to pick up a first tire component 91 from the second conveyor 52 and to deposit said first tire component 91 in a first predetermined position on the support surface 20 of the splice table 2. Preferably, the control unit 54 is configured to determine the first predetermined position based on the stored geometry of the first tire component 91. Preferably, in said first predetermined position, the second lateral side 96 of the first tire component is located within the first splice area S1. More preferably, said second lateral side 96 is arranged along the splice line L.

The control unit 54 is further configured to control the manipulator to subsequently pick up a second tire component 92 from the second conveyor 52 and to deposit said second tire component 92 on the support surface 20 of the splice table 2 in a second predetermined position. The control unit 54 is configured to determine said second predetermined position based on the combination of the stored geometry and the first predetermined position of the first tire component 91, and the stored geometry of the second tire component 92. Preferably, in said second predetermined position, the first lateral side 95 of the second tire component 92 overlaps the second lateral side 96 of the first tire component 91. Additionally or alternatively, the second lateral side 95 of the second tire component 92 is arranged within the second splice area S2.

By using the stored geometries of the first tire component 91 and the second tire component 92 and the first predetermined position of the first tire component 91, the control unit 54 can more accurately and/ore precisely determine the second predetermined position. Accordingly, an overlap between the first tire component 91 and the second tire component 92 can be controlled more accurately and/or precisely. Hence, the stitching device 3 can stitch the first tire component 91 and the second tire component 92 together more reliably. Accordingly the quality of the resulting tire component 9 can be improved.

The control unit 52 may be configured to control the manipulator 6 to subsequently transfer a third tire component 93 from the second conveyor 52 to the support surface 20 of the splice table 2 in a manner similar to the transfer of the second tire component 92 as described above. The control unit 52 may be configured to remove the stored geometry and/or first predetermined position of the first tire component 91 prior to transferring the third tire component 93.

A method for splicing two or more tire components 91, 92, 93, 94 together will be described below with reference to FIGS. 1, 3, 5 and 11.

As is shown in FIG. 1, a first tire component 91, a second tire component 92 and a third tire component 93 have been provided on the support surface 20 of the splice table 2. Preferably, the first tire component 91, the second tire component 92 and the third tire component 93 have been deposited on the support surface 20 by the manipulator 6 in a manner as described above. The first tire component 91 and the second tire component 92 are overlapping in the first splice area S1 and have been previously stitched by the stitching device 3.

As is further shown in FIGS. 1 and 3 the third tire component 93 is overlapping the second tire component 92. In particular within the second stitching area S2. The second tire component 92 is retained by the suction apertures 80 within the second retaining area A2 and the third tire component 93 is retained by the suction apertures 80 within the third retaining area A3. The stitching device 3 has been positioned in the second position. The stitching wheel 31 is being moved along the splice line L for splicing the second and third tire components 92, 93 together.

As is shown in FIG. 11, a fourth tire component 94 has been cut to length by the cutter 55. The method further comprises transferring the fourth tire component 94 to the splice table 2 and stitching the third and fourth tire component 93, 94 together in a manner similar as described above. The method may be repeated for further tire components (not shown) to manufacture a breaker ply 9.

Optionally, the method may further comprise displacing the stitching device 3 to rotate the splice line L to adapt said splice line to a cutting angle of the tire components 91, 92, 93, 94. Said cutting angle may be defined as the oblique angle between the first longitudinal side 95 and the leading end LE of the respective tire component 91, 92, 93, 94.

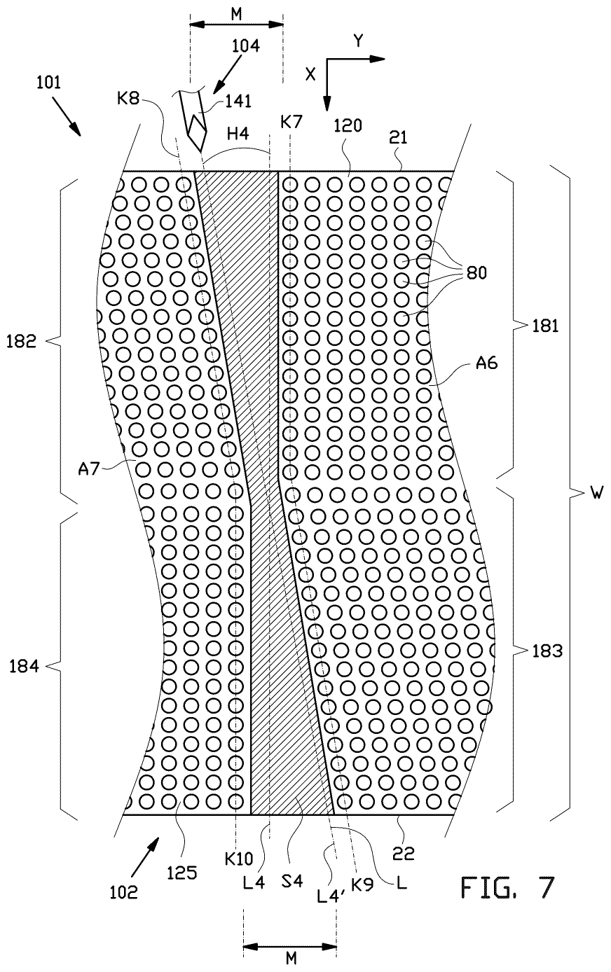

FIG. 7 shows a cutting assembly 101 for cutting elastomeric material, in particular tire components, according to a further embodiment of the invention. The cutting assembly comprises a cutting table 102 and a cutting device 104 for cutting the elastomeric material on said cutting table 102.

The cutting device 104 comprises a knife 141 for cutting through the tire component along a cutting line L. The cutting device 104 is rotatable relative to the cutting table 102 parallel to the support plane P. The cutting device 104 is rotatable to rotate the cutting line L between a fourth primary limit line L4 and a fourth secondary limit line L4′. Said fourth primary limit line L4 and said fourth secondary limit line L4′ extend from the first side 21 of the cutting table 102 to the second side 22 of the cutting table 102 and intersect between said first side 21 and said second side 22. The fourth primary limit line L4 and the fourth secondary limit line L4′ extend at an oblique first cutting angle H4.

The cutting table 102 differs from the previously described splice table 2 in that the suction apertures 80 are distributed over the table body 125 in an alternative aperture pattern different from the previously discussed aperture pattern.

The alternative aperture pattern comprises a first pattern 181 and a second pattern 182 that extend from the first side 21 towards the second side 22 of the cutting table 102 along a seventh pattern line K7 and an eighth pattern line K8, respectively. The alternative aperture pattern further comprises a third pattern 183 and a fourth pattern 184 that extend from the second side 22 towards the first side 21 of the cutting table 102 along a ninth pattern line K9 and a tenth pattern line K10, respectively.

In the embodiment as shown, the patterns 181, 182, 183, 184 are grids or two dimensional arrays of suction apertures 80. Alternatively, the patterns 181, 182, 183, 184 may be rows, columns or one dimensional array similar to the previously described patterns 81, 82, 83, 84, 85, 86 of the splice table 2.

The first pattern 181 and the fourth pattern 184 extend parallel to the fourth primary limit line L4. The second pattern 182 and the third pattern 183 extend parallel to the fourth secondary limit line L4′. In other words, the second pattern 182 and the third pattern 183 extend at oblique angles relative to the fourth pattern 184 and the first pattern 181, respectively.

The aperture pattern defines a fourth processing area or first cutting area S4 of and/or on the support surface 120 between the suction apertures 80 of the first pattern 181, the second pattern 182, the third pattern 183 and the fourth pattern 184. At least a part of said first cutting area S4 is constituted by the area between the fourth primary limit line L4 and the fourth secondary limit line L4′.

The aperture pattern further defines a sixth retaining area A6 and a seventh retaining area A7 of and/or on the support surface 120 on opposite sides of the first cutting area S4 in the second direction Y. In this particular embodiment, the sixth retaining area A6 comprises the first pattern 181 and the third pattern 183. Accordingly, the seventh retaining area A7 comprises the second pattern 182 and the fourth pattern 184. In other words, the sixth retaining area A6 and the seventh retaining area A7 comprise a dense pattern of the suction apertures 80. The fourth processing area S4 comprises a sparse pattern. Preferably, said sparse pattern is free of the suction apertures 80

In the embodiment as shown, the first pattern 181 extends up to the third pattern 183 in the first direction X to form a continuous or contiguous pattern of suction apertures 80 along the boundary between the first cutting area S4 and the sixth retaining area A6. Accordingly, the second pattern 182 extends up to the fourth pattern 184 in the first direction X to form a continuous or contiguous patter of suction apertures 80 along the boundary between the first cutting area S4 and the seventh retaining area A7.

As can further be seen in FIG. 7, at least a part of the suction apertures 80 in both the first pattern 181 and the third pattern 183 extends between the first cutting area S1 and the first side 21 of the cutting table 102 in the first direction X. Accordingly a part of the first cutting area S1 extends between both the first pattern 181 and the third pattern 183, and the second side 22 of the cutting table 102 in the first direction X. Similarly, a part of the cutting area S1 extends between both the second and the fourth pattern 182, 184, and the first side 21 of the cutting table 102 in the first direction X.

It will be apparent to the person skilled in the art that the cutting table 102 and the splice table 2 may be interchangeable. In other words, the cutting table 102 may be used for supporting two or more tire components 91, 92, 93, 94 to be spliced by the stitching device 3 of the previously discussed splice assembly 1. Accordingly, the splice table 2 of the previously discussed splice assembly 1 may be used for supporting elastomeric material to be cut by the cutting device 104.

A method for cutting elastomeric material on the cutting table 102 will be described below.

The method comprises providing elastomeric material on the support surface 120 of the cutting table 102. In particular, the method comprises positioning the elastomeric material on the support surface 120 such that the elastomeric material at least partially overlaps the first cutting area S4, the sixth retaining area A6 and the seventh retaining area A7. Preferably, the method further comprises retaining the elastomeric material by applying a negative pressure to the suction apertures 80 in said sixth retaining area A6 and said seventh retaining area A7. The method further comprises moving the knife 141 along a cutting line L within the first cutting area S4 to cut the elastomeric material. Optionally, the method further comprises the step rotating the cutting device 104 for cutting the elastomeric material along a different cutting line L.

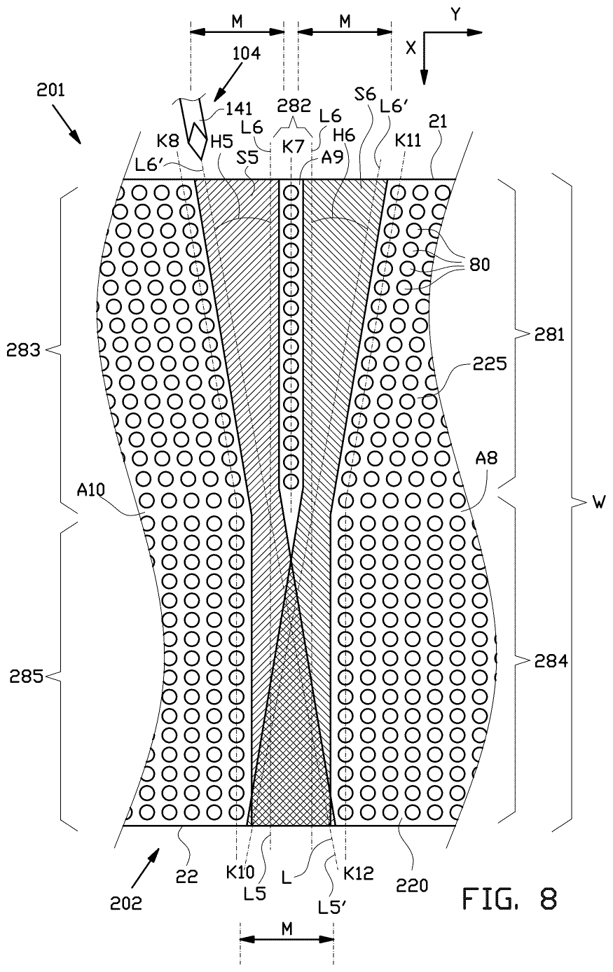

FIG. 8 shows an alternative cutting assembly 201 according to another embodiment of the present invention. The cutting assembly 201 differs from the previously discussed cutting assembly 101 in that the suction apertures 80 are distributed over the table body 225 in a further alternative aperture pattern different from the previously discussed aperture patterns.

The aperture pattern defines a fifth processing area or second cutting area S5 and a sixth processing area or third cutting area S6 of and/or on the support surface 220 between the suction apertures. The second cutting area S5 corresponds or substantially corresponds to the first cutting area S1 of the previously discussed cutting assembly 101. The third pattern 283 and fifth pattern 285 of suction apertures 80 correspond or substantially correspond to the second pattern 182 and the fourth pattern 184 of the previously discussed cutting assembly 101. Accordingly, the tenth retaining area A10 corresponds or substantially corresponds to the seventh retaining area A7.

The aperture pattern defines a ninth retaining area A9 between the second cutting area S5 and the third cutting area S6 in the second direction Y. The ninth retaining area A9 comprises the second pattern 282 that extends along the seventh pattern axis K7. The aperture pattern further defines an eighth retaining area A8 opposite to the tenth retaining area A10 with respect to the third cutting area A6 in the second direction Y. Said eighth retaining area A8 comprises a first pattern 281 and a fourth pattern 284 of suction apertures 80 that extend along an eleventh pattern axis K11 and a twelfth pattern axis K12, respectively. The eighth retaining area A8, the ninth retaining area A9 and the tenth retaining area A10 each comprise a dense pattern of the suction apertures 80 while the second cutting area S5 and the third cutting area S6 each comprise a sparse pattern of the suction apertures 80.

The second cutting area S5 and the third cutting area S6 are mirrored and/or symmetrical relative to the seventh pattern line K7. Accordingly, the eleventh pattern axis K11 and the twelfth pattern axis K12 are mirrored and/or symmetrical to the eighth pattern axis K8 and the tenth pattern axis K10, respectively, relative to the seventh pattern line K7.

The second cutting area S5 and the third cutting area S6 are overlapping and/or have a common cutting area between the fourth pattern 284 and the fifth pattern 285 of suction apertures 80.

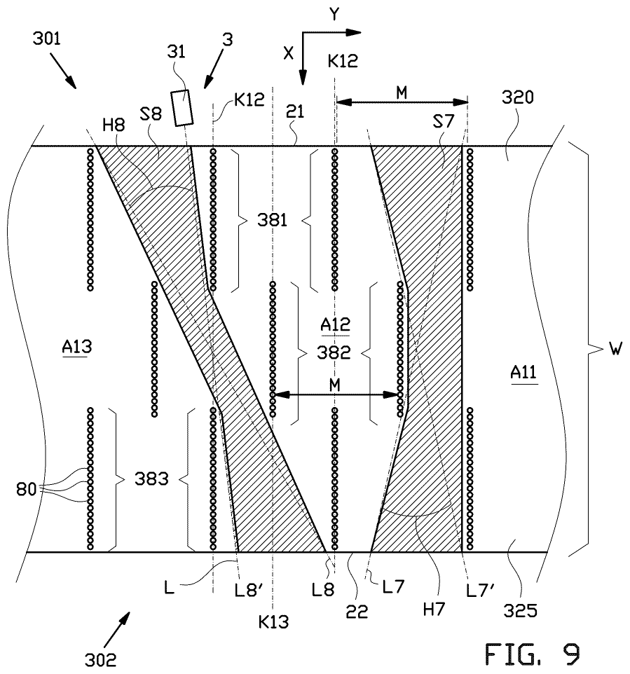

FIG. 9 shows an alternative splice assembly 301 according to yet another embodiment of the invention. The alternative splice assembly 301 differs from the previously discussed splice assembly 1 in that the suction apertures 80 are distributed over the table body 325 in yet another alternative aperture pattern different from the previously discussed aperture patterns.

The aperture pattern comprises a plurality of first patterns 381 that are distributed along the first side 21 of the splice table 302 in the second direction Y. The first patterns 381 extend from the first side 21 towards the second side 22 of the splice table 302. The aperture pattern further comprises a plurality of second patterns 382 that are distributed in the second direction Y. The second patterns 382 extend between the first side 21 and the second side 22 of the splice table 302. In particular, the second patterns 382 are spaced apart from both the first side 21 and the second side 22 of the splice table 302. The aperture pattern further comprises a plurality of third patterns 383 that are distributed along the second side of the splice table 302 in the second direction Y. The third patterns 383 extend from the second side 22 towards the first side 21 of the splice table 302.

In the embodiment as shown, each first pattern 381 extends in line or substantially in line with an associated third pattern 383 along a twelfth pattern line K12. The twelfth pattern lines K12 are equally distributed in the second direction with a mutual distance M. The second patterns 382 each extend along a respective thirteenth pattern line K13 that is centered or located in the middle between two subsequent twelfth pattern lines K12 in the second direction Y. Preferably, the second patterns 382 are further centered relative to the first side 21 and the second side 22 in the first direction X. Preferably, the first pattern 381 and the third pattern 383 extend up to the second pattern 382 in the first direction X.

As is further shown in FIG. 9, a seventh processing area or fourth splice area S7 extends or spans between two subsequent twelfth pattern lines K12 in the second direction Y on the support surface 320. An eighth processing area or fifth splice area S8 extends between or spans three subsequent twelfth pattern lines K12 in the second direction Y. In other words, the fifth splice area S8 may extend over up to two times the mutual distance M between two subsequent or adjacent twelfth pattern lines K12. At least a part of the fourth splice area S7 is constituted by the area between a seventh primary limit line L7 and a seventh secondary limit line L7′ that extends at an oblique seventh processing angle or fourth splice angle H7 with respect to the seventh primary limit line L7. Said seventh primary limit line L7 and said seventh secondary limit line L7′ intersect between the first side 21 and the second side 22 of the splice table 302. Accordingly, at least a part of the fourth splice area S8 is constituted by the area between an eighth primary limit line L8 and an eighth secondary limit line L8′ that extends at an oblique eighth processing angle or fifth splice angle H8 with respect to the eighth primary limit line L8. Said eighth primary limit line L8 and said eighth secondary limit line L8′ intersect between the first side 21 and the second side 22 of the splice table 302.

In the embodiment as shown, the fourth and fifth splice areas S7, S8 are spaced apart in the second direction Y. Alternatively, the fourth and fifth splice areas S7, S8 may partially overlap to allow the splice line L to be rotated over the sum of the seventh splice angle H7 and the eight splice angle H8.

The mutual distances M between the respective pattern lines K1-K13 are larger than the mutual intervals N between the apertures 80 within a respective associated pattern 81-86, 181-184, 281-285, 381-383. Preferably, the mutual distance M is at least twice the mutual interval N. More preferably, the mutual distance M is between three and twenty times the mutual interval N. Most preferably, the mutual distance M is between five and ten times the mutual interval N. In other words, the apertures 80 are arranged densely within a respective pattern 81-86, 181-184, 281-285, 381-383. The patterns 81-86, 181-184, 281-285, 381-383 are sparsely arranged with respect to one another.

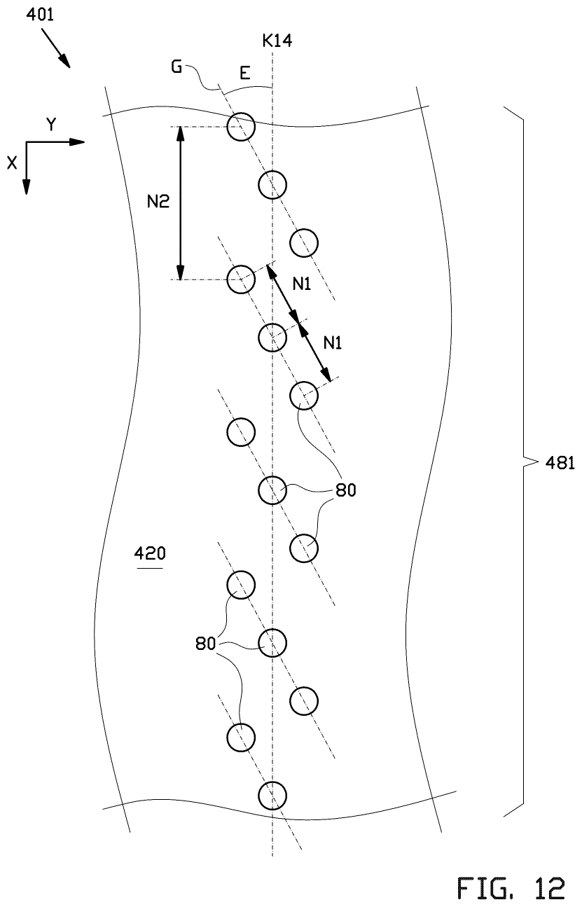

FIG. 12 shows a detailed view of an aperture pattern 481 of an alternative splice table 402. Multiple of said aperture patterns 481 are distributed over the support surface 420 of the splice table 402 in a manner as shown in FIG. 1. The aperture pattern 481 extends along a fourteenth pattern line K14. Preferably, said fourteenth pattern line K14 extends perpendicular or substantially perpendicular to the first side 21 of the splice table 402. In other words, the fourteenth pattern line K14 extends in the first direction X. Alternatively, the fourteenth pattern line K14 may for example extend at an oblique angle with respect to the first side 21 or the second side 22 of the splice table 2.

The aperture pattern 481 comprises a multi dimensional array of suction apertures 80. More particularly, the aperture pattern 481 comprises a plurality of rows of suction apertures 80. Said rows are distributed along the fourteenth pattern line K14 in the first direction X. In the embodiment as shown, the rows each comprise three suction apertures 80. Alternatively, each row may for example comprise two suction apertures 80 or more than three suction apertures 80.

The rows of suction apertures 80 each extend along a respective secondary pattern line G. In other words, the rows of suction apertures 80 are mutually parallel. The secondary pattern line G extends at an oblique pattern angle E with respect to the fourteenth pattern line K14. Preferably, said pattern angle E is between five and forty degrees. More preferably, the pattern angle is between ten and thirty degrees, preferably, the pattern angle E is between fifteen and twenty-five degrees.

Optionally, the pattern angle E is larger than a stitching angle, e.g. the first stitching angle H1. Hence, a stitching line within said stitching angle can be arranged not to correspond with the lines of the aperture pattern 481 that are most closely or densely packed with the suction apertures 80.

When a width of the tire components 91, 92, 93 between the first side 95 and the second side 96 does not correspond to the mutual distance M between the aperture patterns 481, a stitching roller may be moved along a stitching line across one of said aperture patterns 481. The pattern angle E can reduce or minimize the number of suction apertures the stitching roller encounters.

The apertures 80 within a row are spaced apart by a first mutual spacing N1 along the secondary pattern line G. The rows of aperture are spaced apart by a second mutual spacing N2 along the fourteenth pattern line K14, i.e. in the first direction X. Preferably, the second mutual spacing N2 is larger than the first mutual spacing N1. Both the first mutual spacing N1 and the second mutual spacing N2 are smaller than the mutual distance M.

Instead of the aperture pattern 481 that extends along the respective fourteenth pattern line K14, a regular grid of suction apertures 80 that extend at the pattern angle E with respect to the first direction X may be distributed over a part of or the entire support surface 420. The suction apertures may be distributed in a regular grid, preferably a rectangular grid, that has been rotated over the pattern angle E relative to the first side 21 and/or the second side 22 of the splice table 402. Such a grid has the same advantage that the number of vacuum apertures encountered by a splice roller rolling over said grid can be reduced or minimized.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

List of reference numerals

| | |
|---|---|
| 1 | splice assembly |
| 2 | splice table |
| 20 | support surface |
| 21 | first side |
| 22 | second side |
| 25 | table body |
| 3 | stitching device |
| 31 | stitching roller |
| 5 | supply device |
| 51 | first conveyor |
| 52 | second conveyor |
| 53 | width detector |
| 54 | control unit |
| 55 | cutter |
| 6 | transfer device |
| 60 | retaining member |
| 7 | pressure system |
| 70 | opening |
| 71 | first duct |
| 72 | second duct |
| 73 | third duct |
| 74 | connector |
| 78 | pump |
| 80 | suction aperture |
| 81 | first pattern |
| 82 | second pattern |
| 83 | third pattern |
| 84 | fourth pattern |
| 85 | fifth pattern |
| 9 | breaker ply |
| 90 | continuous strip |
| 91 | tire component |
| 92 | tire component |
| 93 | tire component |
| 94 | tire component |
| 95 | first lateral side |
| 96 | second lateral side |
| 101 | cutting assembly |
| 102 | cutting table |
| 120 | support surface |
| 125 | table body |
| 104 | cutting device |
| 141 | knife |
| 181 | first pattern |
| 182 | second pattern |
| 183 | third pattern |
| 184 | fourth pattern |
| 201 | alternative cutting assembly |
| 202 | cutting table |
| 220 | support surface |
| 225 | table body |
| 281 | first pattern |
| 282 | second pattern |
| 283 | third pattern |
| 284 | fourth pattern |
| 285 | fifth pattern |
| 301 | alternative splice assembly |
| 302 | splice table |
| 320 | support surface |
| 325 | table body |
| 381 | first pattern |
| 382 | second pattern |
| 383 | fifth pattern |
| 402 | alternative splice table |
| 420 | support surface |
| 481 | aperture pattern |
| 1001 | prior art splice assembly |
| 1002 | splice table |
| 1020 | support surface |
| 1080 | suction apertures |
| 1090 | contamination |
| A1-A13 | retaining areas |
| B | switching direction |
| C | cutting line |
| D | coupling direction |
| E | pattern angle |
| F | correction direction |
| G | secondary pattern line |
| H1-H8 | processing angle |
| K1-K14 | pattern lines |
| L0 | splice line |
| L | processing line |
| L1-L8 | primary limit lines |
| L1′-L8′ | secondary limit lines |
| LE | leading end |
| M | mutual distance |
| N | mutual spacing |
| N1 | first mutual spacing |
| N2 | second mutual spacing |
| P | support plane |
| S1-S8 | processing areas |
| T | transport direction |
| TE | trailing end |
| W | table width |
| X | first direction |
| Y | first direction |

1-40. (canceled)

41. The processing table for processing elastomeric material, the processing table comprising:
a table body with a support surface for supporting the elastomeric material in a support plane, wherein the support surface extends in a first direction from a first side of the processing table to a second side of the processing table opposite to the first side over a table width; and
a plurality of suction apertures that are distributed over the table body according to an aperture pattern,
wherein the suction apertures are open at the support surface towards the support plane,
wherein the aperture pattern defines a first retaining area and a second retaining area of the support surface,
wherein the first retaining area and the second retaining area each extend from the first side to the second side of the processing table,
wherein the first retaining area and the second retaining area are spaced apart in a second direction perpendicular to the first direction,
wherein the aperture pattern further defines a processing area of the support surface between the suction apertures,
wherein the processing area extends from the first side to the second side of the processing table and between the first retaining area and the second retaining area in the second direction,
wherein the aperture pattern comprises a first pattern of suction apertures within the first retaining area and a second pattern of suction apertures within the second retaining area,
wherein the first pattern extends between the first side and the second side along a part of a first pattern line that extends from the first side to the second side to define a part of a boundary between the first retaining area and the processing area, and
wherein the second pattern extends between the first side and the second side along at least a part of a second pattern line that extends from the first side to the second side to define at least a part of a boundary between the second retaining area and the processing area,
wherein the first pattern extends from the first side towards the second side over twenty to eighty percent of the table width,
wherein the second pattern extends from the second side towards the first side over twenty to eighty percent of the table width.

42. The processing table according to claim 41, wherein at least a part of the first retaining area extends between the processing area and the first side in the first direction, or
wherein at least a part of the second retaining area extends between the processing area and the second side in the first direction.

43. The processing table according to claim 41, wherein the first pattern extends over thirty to seventy percent of the table width.

44. The processing table according to claim 41, wherein the first pattern line extends perpendicular to the first side.

45. The processing table according to claim 41, wherein the first pattern is a row, a column or an array of suction apertures.

46. The processing table according to claim 41, wherein the second pattern extends over thirty to seventy percent of the table width.

47. The processing table according to claim 41, wherein the first pattern line and the second pattern line are parallel, wherein the first pattern line and the second pattern line are spaced apart over a first mutual distance.

48. The processing table according to claim 47, wherein the first mutual distance is larger than a mutual spacing between the suction apertures along the first pattern line or the second pattern line.

49. The processing table according to claim 41, wherein the aperture pattern further comprises a third pattern of suction apertures within the first retaining area,
wherein the third pattern extends between the first side and the second side along at least a part of a third pattern line different from the first pattern line,
wherein the third pattern line extends from the first side to the second side to define a further part of the boundary between the first retaining area and the processing area.

50. The processing table according to claim 49, wherein the first pattern extends from the first side towards the second side and wherein the third pattern extends from the second side towards the first side over twenty to eighty percent of the table width.

51. The processing table according to claim 49, wherein the first pattern line and the third pattern line are parallel,
wherein the first pattern line and the third pattern line are spaced apart over a second mutual distance.

52. The processing table according to claim 51, wherein the second mutual distance is larger than a mutual spacing between the suction apertures along the first pattern line or the third pattern line.

53. The processing table according to claim 51, wherein the first pattern line is arranged between the second pattern line and the third pattern line in the second direction.

54. The processing table according to claim 49, wherein the first pattern line and the third pattern line intersect at a first intersection between the first side and the second side.

55. The processing table according to claim 54, wherein the first pattern extends from the first side towards or up to the first intersection, or
wherein the third pattern extends from the second side towards or up to the first intersection.

56. The processing table according to claim 49, wherein the aperture pattern further comprises a fourth pattern of suction apertures within the second retaining area,
wherein the fourth pattern extends between the first side and the second side along at least a part of a fourth pattern line different from the second pattern line,
wherein the fourth pattern line extends from the first side to the second side to define a further part of the boundary between the second retaining area and the processing area.

57. The processing table according to claim 56, wherein the second pattern extends from the second side towards the first side, and
wherein the fourth pattern extends from the first side towards the second side over twenty to eighty percent of the table width.

58. The processing table according to claim 56, wherein the third pattern line and the fourth pattern line are parallel, and
wherein the third pattern line and the fourth pattern line are spaced apart over a third mutual distance.

59. The processing table according to claim 58, wherein the third mutual distance is larger than a mutual spacing between the suction apertures along the third pattern line or the fourth pattern line.

60. The processing table according to claim 58, wherein the second pattern line is arranged between the first pattern line and the fourth pattern line in the second direction.

61. The processing table according to claim 56, wherein the second pattern line and the fourth pattern line intersect at a second intersection between the first side and the second side,
wherein the fourth pattern extends from the first side towards or up to the second intersection, or
wherein the second pattern extends from the second side towards or up to the second intersection.

62. The processing table according to claim 41, wherein the processing area is a first processing area, wherein aperture pattern further defines a second processing area of the support surface that is displaced in the second direction relative to the first processing area.

63. The processing table according to claim 41, wherein the processing table further comprises a vacuum system that is connected to the suction apertures for applying a negative pressure to said suction apertures for retaining the elastomeric material.

64. A processing assembly for processing elastomeric material, wherein the processing assembly comprises a processing table according to claim 41 and a processing device for processing the elastomeric material on said processing table,
wherein the processing device is arranged for processing the elastomeric material along an processing line extending from the first side to the second side of the processing table within the processing area.

65. The processing assembly according to claim 64, wherein the processing assembly is further arranged for rotating the processing line between a primary limit line extending from the first side to the second side and a secondary limit line extending from the first side to the second side at an oblique processing angle with respect to the primary limit line and intersecting with said primary limit line between the first side and the second side.

66. The processing assembly according to claim 64, wherein the processing assembly is further arranged for displacing the processing line in the second direction.

67. The processing assembly according to claim 64, wherein the processing device is a stitching device for stitching a first tire component and a second tire component together along the processing line.

68. The processing assembly according to claim 67, wherein the processing device comprises a stitching roller,
wherein the stitching roller has a roller width, and
wherein a minimal width of the processing area in a direction perpendicular to the processing line is larger than the roller width of the stitching roller.

69. The processing assembly according to claim 64, wherein the processing device is a cutter for cutting a tire component along the processing line.

70. A method for processing an elastomeric material using the processing table according to claim 41, wherein the method comprises the steps of:
a) providing the elastomeric material at the support surface;
b) retaining the elastomeric material by applying a negative pressure at the plurality of suction apertures in at least one of the first retaining area and the second retaining area; and
c) processing the elastomeric material along a processing line extending from the first side of the table to the second side of the table within the processing area.

71. The method according to claim 70, wherein the method further comprises adapting an angle of the processing line with respect to the processing table within the processing area defined by said processing table.

72. The method according to claim 70, wherein the elastomeric material comprises a first tire component and a second tire component, wherein step a) comprises:
placing the first tire component at the first retaining area such that a lateral portion of said first tire component extends within the first processing area; and
placing the second tire component at the second retaining area such that a lateral portion of said second tire component overlaps with the lateral portion of the first tire component in the first processing area.
